(19) United States
(12) Patent Application Publication
(10) Pub. No.: US 2019/0386359 A1
(43) Pub. Date: Dec. 19, 2019

(54) CELL CARRIER COMPRISING PHASE CHANGE MATERIAL

(71) Applicant: CORVUS ENERGY INC., Richmond (CA)

(72) Inventor: David LOKHORST, Richmond (CA)

(73) Assignee: Corvus Energy Inc., Richmond, BC (CA)

(21) Appl. No.: 16/312,053

(22) PCT Filed: Jun. 20, 2017
(86) PCT No.: PCT/CA2017/050754

§ 371 Date: Dec. 20, 2018

Related U.S. Application Data
(60) Provisional application No. 62/352,211, filed on Jun. 20, 2016.

(51) Int. Cl. H01M 10/659; C09K 5/06; C09K 5/04; H01M 10/6569; H01M 2/10

(52) U.S. Cl. CPC H01M 10/659; C09K 5/06; H01M 2/1061; H01M 10/6569; H01M 2/1077; C09K 5/04

(57) ABSTRACT

A cell carrier includes a phase change material compartment containing phase change material. The phase change material has a phase transition temperature between a normal operating temperature of the battery cell and a self-heating point of the battery cell, and the phase change material transitions from a solid state to a liquid state or from a liquid state to a gaseous state when heated to the phase transition temperature.

### TECHNICAL FIELD

The present disclosure is directed at a cell carrier comprising phase change material.

### BACKGROUND

Fossil fuels continue to be displaced as an energy source in both industrial and consumer uses. One way in which fossil fuels are being displaced is by replacing internal combustion engines with electric motors. Replacing an internal combustion engine with an electric motor typically involves swapping a fuel tank for battery modules, with the battery modules providing the electricity required to operate the electric motor.

A battery module typically comprises multiple battery cells electrically connected in one or both of series and parallel. One example type of battery cell is a “pouch cell” in which the rigid exterior of a conventional battery cell is replaced with a flexible pouch. Flexible and electrically conductive tabs extend from an edge of the pouch and are welded to the cell's electrodes, which are contained within the pouch; these tabs allow the cell to be electrically connected to a load. Pouch cells often have a lithium polymer battery chemistry.

Swapping the rigid exterior of a conventional battery cell for a flexible pouch reduces the weight of the battery module but reduces the inherent structural integrity of the cell. To compensate for this decrease in integrity, each of the pouch cells in a battery module typically rests within a battery cell carrier, and the battery cell carriers are physically coupled together to form a stack assembly that has sufficient structural integrity for practical use. The stack assembly is housed within an enclosure, which protects the stack assembly from the environment.

### SUMMARY

According to a first aspect, there is provided a cell carrier. The cell carrier comprises a cell compartment for receiving a battery cell; a phase change material compartment thermally coupled to the cell compartment; and a phase change material located in the phase change material compartment. The phase change material has a phase transition temperature between a normal operating temperature of the battery cell and a self-heating point of the battery cell. The phase change material transitions from a solid state to a liquid state or from a liquid state to a gaseous state when heated to the phase transition temperature.

The battery cell may be operable within a range of normal operating temperatures, and the phase transition temperature may be between an upper bound of the range of normal operating temperatures and the self-heating point of the battery cell.

The phase transition temperature may be a melting temperature of the phase change material.

The cell compartment may comprise a backing against which the battery cell is placed when the battery cell is in the cell compartment, and the backing may comprise a wall of the phase change material compartment.

The phase change material may directly contact the backing.

The carrier may comprise a raised edge extending from the backing, and the raised edge may comprise at least part of a periphery of the cell compartment on one side of the backing and of the phase change material compartment on an opposite side of the backing.

A phase change material compartment cap may be opposite the backing and coupled to the raised edge.

The phase change material compartment may be fluidly sealed.

The phase change material may have a latent heat of melting of between 100 kJ/kg and 500 kJ/kg.

The melting temperature of the phase change material may be between 80° C. and 120° C.

According to another aspect, there is provided a battery module comprising a stack of cell carrier assemblies. Each of the cell carrier assemblies comprises a cell carrier and a battery cell. The cell carrier comprises a cell compartment for receiving a battery cell; a phase change material compartment thermally coupled to the cell compartment; and a phase change material located in the phase change material compartment. The phase change material has a phase transition temperature between a normal operating temperature of the battery cell and a self-heating point of the battery cell. The phase change material transitions from a solid state to a liquid state or from a liquid state to a gaseous state when heated to the phase transition temperature. For any two neighboring cell carrier assemblies that directly contact each other, the phase change material of one of the neighboring cell carrier assemblies is located between the battery cells of the neighboring cell carrier assemblies.

The phase change material compartment of one of the neighboring cell carrier assemblies may directly contact the other of the neighboring cell carrier assemblies.

The battery module may further comprise a heat sink thermally coupled to the stack, and each of the cell carrier assemblies may further comprise a heat conductive sheet positioned to conduct heat from the battery cell to the heat sink.

The heat conductive sheet may be layered on the battery cell and extend out of the cell compartment to an edge of the cell carrier that contacts the heat sink.

The phase change material compartment of one of the neighboring cell carrier assemblies may directly contact the heat conductive sheet of the other of the neighboring cell carrier assemblies.

The battery cell may be operable within a range of normal operating temperatures, and the phase transition temperature may be between an upper bound of the range of normal operating temperatures and the self-heating point of the battery cell.

The phase transition temperature may be a melting temperature of the phase change material.

The cell compartment of each of the cell carrier assemblies may comprise a backing against which the battery cell is placed when the battery cell is in the cell compartment, and the backing may comprise a wall of the phase change material compartment.

The phase change material may directly contact the backing.

The cell carrier of each of the cell carrier assemblies may comprise a raised edge extending from the backing, and the raised edge may comprise at least part of a periphery of the cell compartment on one side of the backing and of the phase change material compartment on an opposite side of the backing.

The cell carrier of each of the cell carrier assemblies may further comprise a phase change material compartment cap opposite the backing and coupled to the raised edge.

The phase change material compartment may be fluidly sealed.

The phase change material may have a latent heat of melting of between 100 kJ/kg and 500 kJ/kg.

The melting temperature of the phase change material may be between 80° C. and 120° C.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIGS. 1A and 1B are front and rear perspective views, respectively, of one example embodiment of a cell carrier comprising phase change material.

FIG. 2 is a graph representing heating with and without phase change material, according to one example embodiment.

FIG. 3A is a cross-section of an example embodiment of a battery module comprising a stack of cell carrier assemblies, each of which comprises phase change material.

FIG. 3B is an exploded view of one of the cell carrier assemblies of FIG. 3A.

FIGS. 4A to 4C are graphs representing temperature of a battery cell undergoing thermal runaway (FIG. 4A), of the phase change material comprising part of the cell carrier containing the battery cell that is undergoing thermal runaway (FIG. 4B), and of a battery cell that neighbors the battery cell that is undergoing thermal runaway (FIG. 4C).

FIG. 5A is a perspective view, respectively, of an example embodiment of a stack of cell carrier assemblies, each of which comprises phase change material.

FIG. 5B is an exploded view of one of the cell carrier assemblies of FIG. 5A.

### DETAILED DESCRIPTION

In certain extreme circumstances, a condition known as “self-heating” can occur within a lithium ion battery cell, which can cause the battery cell to enter a state known as “thermal runaway”. “Self-heating” refers to a self-reinforcing exothermic reaction that causes the battery cell to heat to a temperature that exceeds the temperature that would result from the battery cell's being heated by an external heating source alone; the temperature at which self-heating begins is referred to as the “self-heating point”. “Thermal runaway” refers to a positive feedback process by which the temperature of the battery cell increases as a result of an exothermic reaction. The exothermic reaction may, for example, result from discharging excessive current from the battery cell or from operating the battery cell in an excessively hot environment. Eventually, uncontrolled thermal runaway causes one or both of the battery cell's temperature and pressure to increase to the extent that the battery cell may combust, explode, or both.

When one cell in a stack of battery cells experiences thermal runaway, the heat that that cell releases can cause neighboring cells to also undergo thermal runaway, thereby starting a chain reaction that is potentially catastrophic. The embodiments described herein are directed at using a phase change material (“PCM”) to absorb heat released by a cell when it enters thermal runaway, thereby inhibiting thermal runaway in neighboring cells.

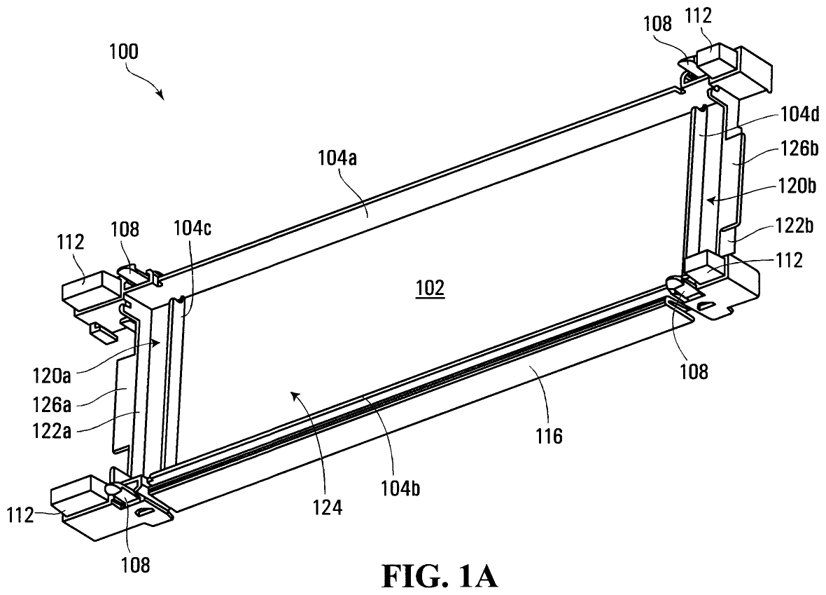

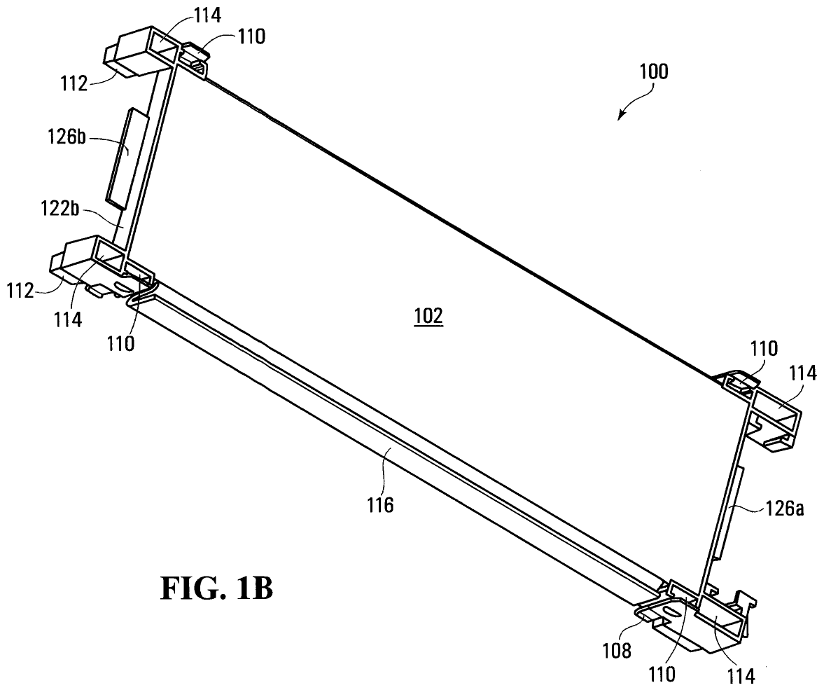

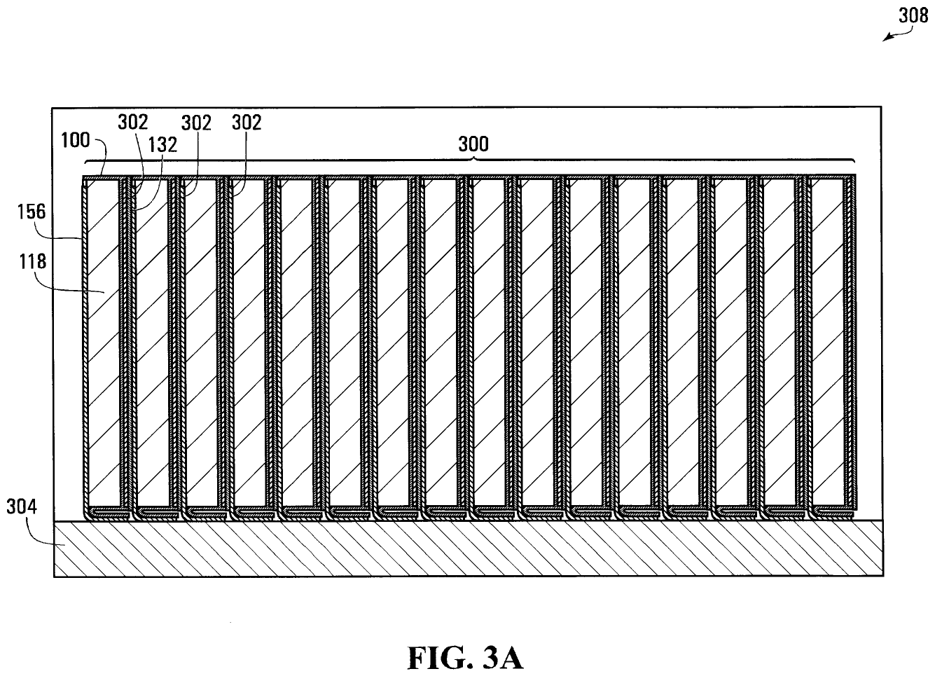

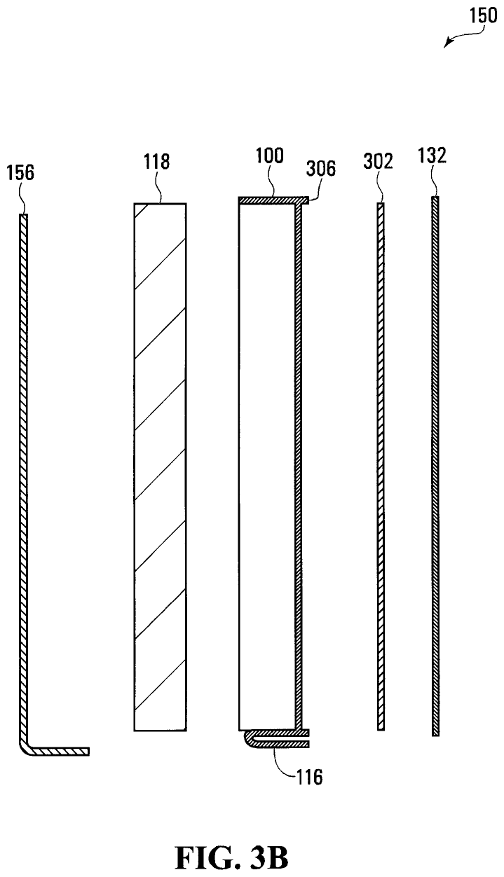

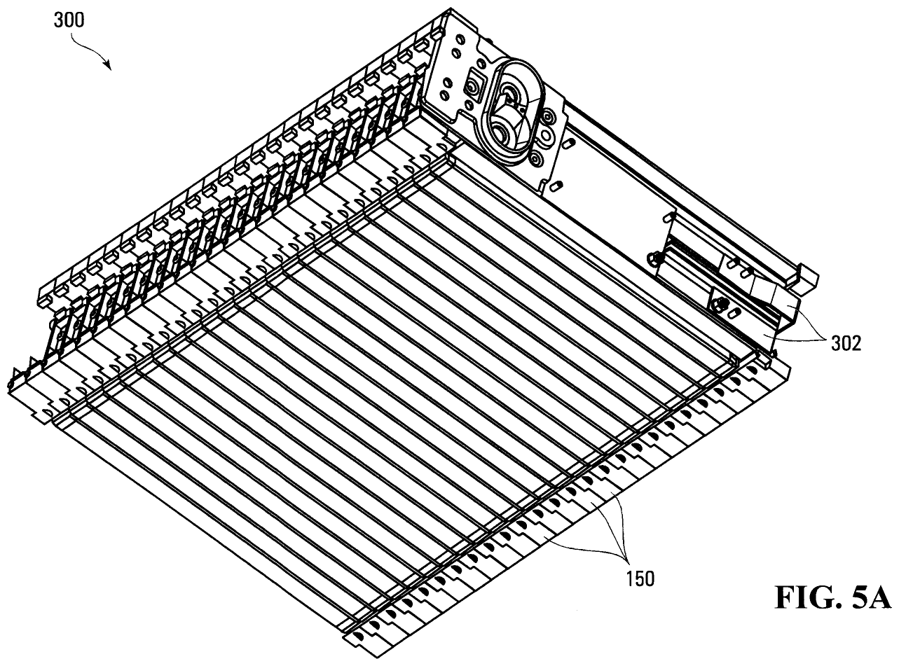

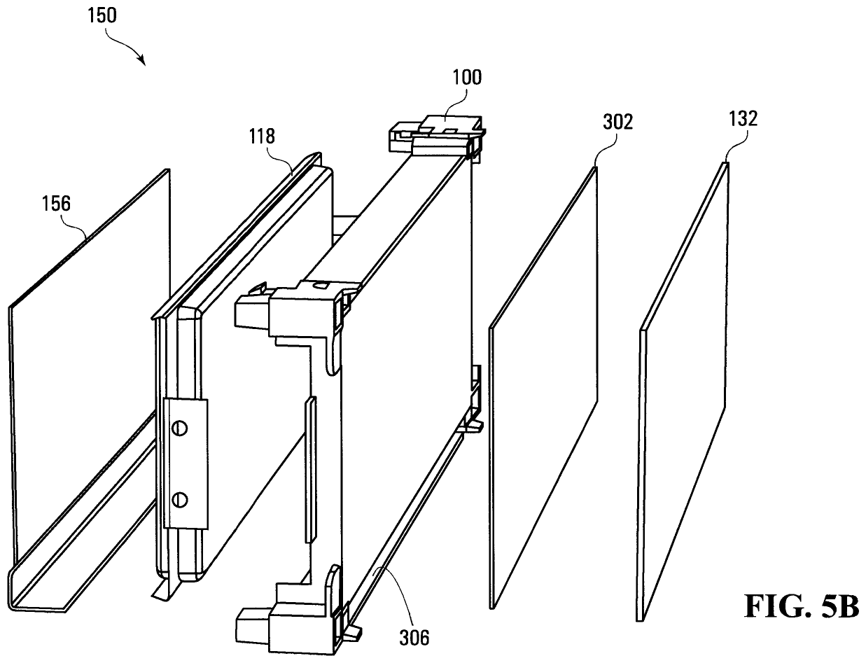

FIGS. 1A and 1B respectively show front perspective and rear perspective views of one embodiment of a cell carrier 100. The cell carrier 100 comprises a backing 102 against which a pouch cell 118 (shown in FIGS. 3A, 3B, and 5B) is secured. The backing 102 may be relatively rigid for the purposes of structural integrity, or alternatively may be relatively flexible. The securing of the pouch cell 118 may be done, for example, by any one or more of using an adhesive that secures the cell 118 to the backing 102, clamping of the cell 118 against the backing 102 by a clamping mechanism (not shown), and compression of the cell 118 against the backing 102 by neighboring cell carriers 100 when the cell carrier 100 comprises part of a stack assembly 300 (shown in FIG. 3). Extending perpendicularly from the front side of the backing 102 are a top wall 104a extending along the backing's 102 top edge, a bottom wall 104b extending along the backing's 102 bottom edge, a left wall 104c extending across a left portion of the backing 102, and a right wall 104d extending along a right portion of the backing 102; these four walls 104a-d collectively delimit a cell compartment 124 for receiving the pouch cell 118.

A leftmost wall 122a extends along the backing's 102 left edge, and the leftmost wall 122a, left wall 104c, top wall 104a, and bottom wall 104b collectively delimit a first tab compartment 120a that is positioned to receive a foil tab that comprises part of the pouch cell 118 and that is electrically connected to one of the cell's 118 electrodes. Extending leftwards from the leftmost wall 122a is a first tab platform 126a for supporting part of the foil tab that is otherwise contained in the first tab compartment 120a. Similarly, a rightmost wall 122b extends along the backing's 102 right edge, and the rightmost wall 122b, right wall 104d, top wall 104a, and bottom wall 104b collectively delimit a second tab compartment 120b that is positioned to receive another of the pouch cell's 118 foil tabs that is electrically connected to the other of the cell's 118 electrodes. Extending rightwards from the rightmost wall 122b is a second tab platforms 126b for supporting part of the foil tab that is otherwise contained in the second tab compartment 120b.

Each corner of the cell carrier 100 comprises a carrier coupling mechanism for coupling the cell carrier 100 to a neighboring cell carrier 100 located in front of or behind the cell carrier 100. The two carrier coupling mechanisms connected to the left corners of the carrier 100 (“left corner carrier coupling mechanisms”) are identical. Each of these carrier coupling mechanisms comprises a tab 108 extending forwards and an adjacent slot 110 with a notch in its side wall to detachably couple to the tab 108 of a neighboring cell carrier 100. To the left of the tab 108 and slot 110 is a forwardly extending protrusion 112 behind which is a recess 114 for receiving and forming an interference fit with the protrusion 112 of a neighboring cell carrier 100. The two carrier coupling mechanisms connected to the right corners of the carrier 100 (“right corner carrier coupling mechanisms”) are also identical and mirror the left corner carrier coupling mechanisms, except that the protrusions 112 and recesses 114 of the right corner carrier coupling mechanisms are smaller than those of the left corner carrier coupling mechanisms.

In the depicted embodiment, the carrier coupling mechanisms provide a releasable coupling between neighboring carriers 100 and are positioned at the carrier's 100 corners. In a different embodiment (not depicted) and more generally, the carrier coupling mechanism may be a releasable coupling that comprises a male portion positioned to couple to a first neighboring cell carrier 100 on one side of the cell carrier 100 and a female portion positioned to couple to a second neighboring cell carrier 100 on an opposite side of the cell carrier 100. In another different embodiment (not depicted), the carriers 100 may be non-releasably coupled together using a non-releasable technique, such as with an adhesive.

Extending on an outer surface of the bottom wall 104b is a spring 116. In the depicted embodiment, the spring 116 comprises a curved cantilevered portion that is affixed at one end to the outer surface of the bottom wall 104b. A substantially flat actuator portion is affixed to the other end of the cantilevered portion at a flexible fulcrum and is designed to be compressed by virtue of contact with the stack assembly enclosure, as discussed in more detail below.

While one particular embodiment of the spring 116 is depicted, in different embodiments (not depicted) the spring 116 may be differently designed. For example, the spring 116 may extend intermittently, as opposed to continuously, along the bottom wall 104b; that is, the spring 116 may comprise a series of discrete spring portions, each of which may be independently compressed. In another different embodiment (not depicted), the spring 116 may comprise a different type of spring, such as a coil spring. In another different embodiment (not depicted), the spring 116 may comprise a combination of multiple types of springs; for example, the spring 116 may comprise different discrete spring portions, with some of those spring portions being coil springs and some of those spring portions being cantilevered springs. In another different embodiment (not depicted), the spring 116 may not be located along the portion of the bottom wall 104b that delimits the cell compartment 124; for example, the spring 116 may be affixed directly to one or both of the bottom left and bottom right corner carrier coupling mechanisms, or may be affixed to another portion of the cell carrier 100 not depicted in the current embodiment. Additionally, while in the depicted embodiment the spring 116 extends past the periphery of the cell compartment 124 by virtue of extending below the bottom wall 104b, in another different embodiment (not depicted), the spring 116 may not extend past the periphery of the cell compartment 124. For example, the spring 116 may extend within the cell compartment 124 (e.g., be connected to any of the walls 104a-d and extend towards the interior of the cell compartment 124), and the stack assembly enclosure may be shaped so that it nonetheless compresses the spring 116 when the entire battery module is assembled.

FIGS. 3B and 5B show exploded views of two example embodiments of cell carrier assemblies 150, each of which comprises the cell carrier 100. Each of the cell carrier assemblies 150 also comprises the battery cell 118, which rests within the cell compartment 124 against one side of the backing 102 (this side is hereinafter referred to as the “front side” of the backing 102); a heat conductive sheet 156, which is laid over the cell 118 and which extends out from the cell compartment 124 and under the spring 116; and a phase change material compartment (“PCM compartment”) that contains a phase change material (“PCM”) 302.

The PCM 302 is solid at normal operating temperatures of the battery cell 118; in an example embodiment in which the cell 118 is a nickel-magnesium-cobalt cell, the normal operating temperature of the cell 118 is from 0° C. to 60° C.; in different embodiments, the normal operating temperature of the cell 118 may vary with, for example, cell chemistry. For example, lithium titanate cells may be constructed so as to have a range of −50° C. to 70° C. An example of the PCM 302 is savE® HS 89 material from Pluss® Polymers Pvt. Ltd., which has a melting temperature of 88° C. The melting temperature of the PCM 302 is selected to be between a normal operating temperature of the battery and a self-heating point of the battery cell 118 and, in certain embodiments in which the normal operating temperature spans a range of temperatures, is selected to be between the upper bound of the range of normal operating temperature of the battery cell 118 and the self-heating point of the battery cell 118. For example, in different embodiments the melting temperature of the PCM 302 is selected from the range of 80° C. to 120° C., and may be, for example, any of 80° C., 85° C., 90° C., 95° C., 100° C., 105° C., 110° C., 115° C., and 120° C.

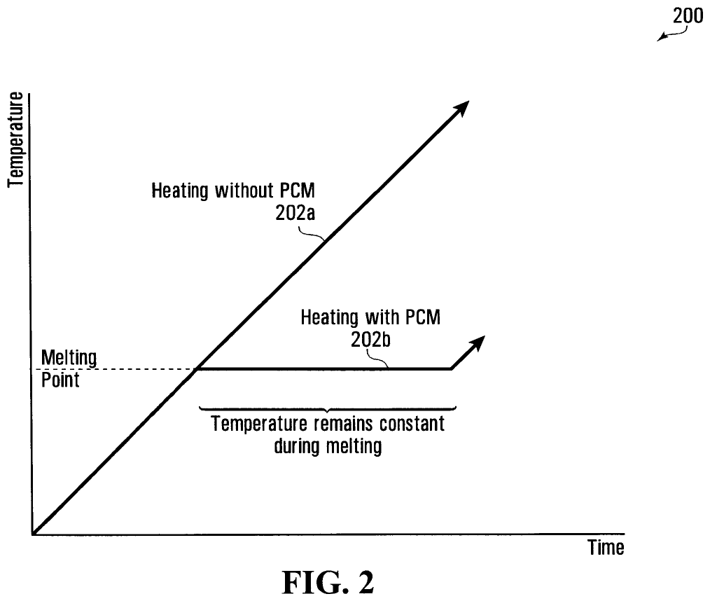

FIG. 2 shows a graph 200 depicting an example of how the temperature of the PCM 302 changes over time when exposed to an external heat source (not shown) as opposed to how the temperature of a material that does not experience a phase change (a “non-PCM”) changes over the same period when exposed to the same heat source. The graph 200 shows two curves: a non-PCM curve 202a in which the temperature of the non-PCM increases linearly with time exposed to the heat source; and a PCM curve 202b that shows how, when the temperature of the PCM 302 reaches its melting temperature (labeled as “melting point” in FIG. 2), the heat from the heat source is used to change the phase of the PCM 302 as opposed to increase the temperature of the PCM 302. The duration during which the temperature of the PCM 302 remains constant is equal to mass of the PCM 302 multiplied by its latent heat of melting and divided by the rate at which the PCM 302 absorbs heat from the heat source. In certain example embodiments, the latent heat of melting of the PCM 302 ranges from 100 kJ/kg to 500 kJ/kg and may be, for example, any of 100 kJ/kg, 110 kJ/kg, 120 kJ/kg, 130 kJ/kg, 140 kJ/kg, 150 kJ/kg, 160 kJ/kg, 170 kJ/kg, 180 kJ/kg, 190 kJ/kg, 200 kJ/kg, 210 kJ/kg, 220 kJ/kg, 230 kJ/kg, 240 kJ/kg, 250 kJ/kg, 260 kJ/kg, 270 kJ/kg, 280 kJ/kg, 290 kJ/kg, 300 kJ/kg, 310 kJ/kg, 320 kJ/kg, 330 kJ/kg, 340 kJ/kg, 350 kJ/kg, 360 kJ/kg, 370 kJ/kg, 380 kJ/kg, 390 kJ/kg, 400 kJ/kg, 410 kJ/kg, 420 kJ/kg, 430 kJ/kg, 440 kJ/kg, 450 kJ/kg, 460 kJ/kg, 470 kJ/kg, 480 kJ/kg, 490 kJ/kg, and 500 kJ/kg. For example, the savE® HS 89 material discussed above has a latent heat of melting of 180 kJ/kg.

The PCM compartment is on a side of the backing 102 opposite the front side (this side of the backing 102 is hereinafter the “rear side” of the backing 102). The PCM compartment is defined by the rear side of the backing 102, a lip 306 extending along a periphery of the rear side of the backing 102, and a PCM compartment cap 132 that is secured to the lip 306. In the depicted embodiment, a raised edge extending from the backing 102 and that comprises the top and bottom walls 104a,b on the front side of the backing 102 comprises two opposing edges of the lip 306 on the rear side of the backing 102. The left and right walls 104c,d on the front side of the backing 102 are aligned with the other two edges of the lip 306 on the rear side of the backing 102. The PCM 302 is located between the rear side of the backing 102 and the PCM compartment cap 132. In certain embodiments, the PCM 302 at normal operating temperatures of the battery cell 118 is solid; for example, the PCM 302 in its solid form may be granular or, as illustrated in FIGS. 3B and 5B, a solid sheet of material. In certain embodiments, the PCM 302 is melted and poured into the PCM compartment during manufacturing of the cell carrier 100, following which the PCM 302 cools and solidifies prior to being used to regulate temperature of the battery cell 118. While in the depicted embodiment the PCM 302 is planar and overlaps substantially the entire area of the cell 118, in different embodiments (not depicted) the PCM 302 may be one or both of non-planar and may have dimensions substantially different from those of the cell 118. Additionally, in the depicted embodiments thermal coupling between the cell compartment 124 and the PCM compartment is conductive as each of the PCM 302 and the cell 118 directly contacts the backing 102; however, in different embodiments (not depicted) heat may be transferred using any one or more of convection, conduction, and radiation, depending on the structure of the cell carrier 100. For example, in one non-depicted embodiment, the front side of the backing 102 comprises one or both of ribs and stand-offs that result in an air gap being present between the cell 118 and the backing 102; in this non-depicted embodiment, one or both of radiation and convection play a significant role in thermally coupling the cell 118 to the PCM compartment.

The PCM compartment in the depicted embodiments is fluidly sealed; in different embodiments (not depicted), the PCM compartment may not be fluidly sealed and instead one or both of the amount of the PCM 302 used and the orientation of the carrier 100 during use may permit the PCM 302 to melt without leaking out of the PCM compartment. For example, the top of the PCM compartment may be left open and the amount of PCM 302 placed in the compartment may be selected such that when the PCM 302 melts, there is insufficient melted PCM to flow out the top of the compartment during thermal runaway.

Referring now to FIG. 5A, there is depicted a stack assembly 300 comprising 24 of the cell carrier assemblies 150 of FIG. 5B mechanically coupled together in series using the cell carriers’ 100 carrier coupling mechanisms. Bus bars 302 electrically couple the cells 118 together in any suitable electrical configuration; for example, in the depicted embodiment the cells 118 are electrically coupled in a 12s2p arrangement. As described above in respect of the cell carrier assembly 150, portions of the heat conductive sheets 156 extend under the cell carrier assemblies 150. In another different embodiment (not depicted), the carriers 100 may be clamped together, such as by running a threaded dowel through the carriers 100 and clamping the ends of the stack 300 together using nuts.

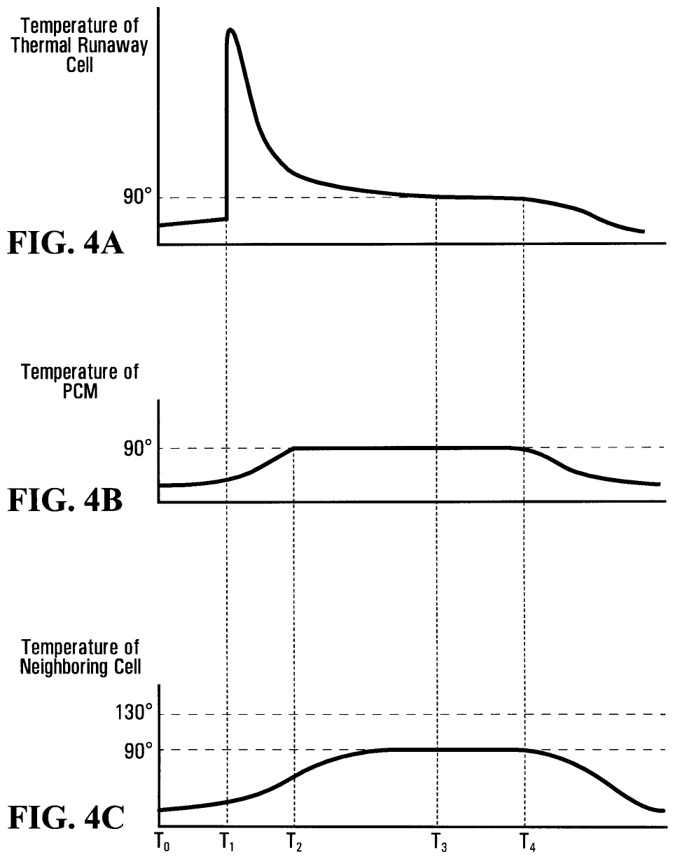

Referring now to FIG. 3A, there is depicted a sectional view of a battery module 308 that comprises a stack assembly 300 comprising 16 of the cell carrier assemblies 150 of FIG. 3B and a heat sink 304. The cell carrier assemblies 150 are mechanically coupled together in series and the heat sink 304 is in contact with the heat conductive sheets 156 that extend over the bottom edges of the cell carriers 100. Sheets of the PCM 302 housed in the PCM compartments of the cell carrier assemblies 150 separate the battery cells 118 from each other. The cell carrier assemblies 150 are stacked such that for any two neighboring cell carrier assemblies 150 that directly contact each other, the PCM compartment cap 132 of one of the neighboring cell carrier assemblies 150 directly contacts the heat conductive sheet 156 of the other of the neighboring cell carrier assemblies 150; this facilitates heat conduction away from the cell carrier assemblies 150 to the heat sink 304. In the event any one of the cells 118 enters thermal runaway, FIGS. 4A to 4C depict how the PCM 302 operates to inhibit the spread of thermal runaway throughout the entire stack assembly 300. In another example embodiment (not depicted), the carrier's 100 walls 104a-d are increased in height such that the PCM compartment cap 132 of one of the neighboring cell carrier assemblies 150 does not directly contact the heat conductive sheet 156 of the other of the neighboring cell carrier assemblies 150. In this example embodiment, one or both of radiation and convection play a significant role in thermally coupling the neighboring cell carrier assemblies 150 to each other.

FIG. 4A is a graph showing the temperature of one of the cells 118 (“thermal runaway cell”) in the battery module 308 that is undergoing thermal runaway vs. time; FIG. 4B is a graph showing the temperature of the PCM 302 in the cell carrier 100 for the cell 118 whose temperature is graphed in FIG. 4A vs. time; and FIG. 4C is a graph of temperature of a cell 118 (“neighboring cell”) in a cell carrier assembly 150 that neighbors and directly contacts the PCM compartment containing the PCM 302 whose temperature is shown in FIG. 4B vs. time. The melting temperature of the PCM 302 depicted in FIGS. 4A and 4B is 90° C.

At time T₀, an internal defect such as an internal short circuit occurs in the thermal runaway cell 118. At time T₁, this defect causes the thermal runaway cell 118 to enter thermal runaway; the thermal runaway cell 118 consequently rapidly increases in temperature to over 400° C. in less than ten seconds, as shown in FIG. 4A. While experiencing thermal runaway, the thermal runaway cell 118 expels hot gases into the battery module 308.

Starting at time Ti, the thermal runaway cell 118 transfers significant heat energy into its environment, such as the cell carrier 100, the heat conductive sheet 156, and the PCM 302. Between times T₁ and T₂, the PCM 302 absorbs some of this heat but remains solid. During this time the PCM 302 also transfers heat to the neighboring cell 118; consequently, the temperatures of the PCM 302 and neighboring cell 118 increase, as shown in FIGS. 4B and 4C.

At time T₂, the PCM 302 reaches its melting temperature and begins melting. While melting, the PCM 203 absorbs the heat it is exposed to and stays at a constant temperature. Because heat transferred from the thermal runaway cell 118 to the neighboring cell 118 primarily passes through the PCM 302, and because the PCM 302 temperature peaks at its melting temperature, the neighboring cell's 118 temperature also peaks at approximately the melting temperature of the PCM 302. As the melting temperature of the PCM 302 is selected to be less than the self-heating point, the thermal runaway cell 118 does not cause the neighboring cell 118 to also go into thermal runaway.

At time T₃, the thermal runaway cell 118, which has been cooling, cools to the PCM's 302 melting temperature. The PCM 302 accordingly ceases further melting.

Between times T₃ and T₄, the thermal runaway cell 118 and the PCM 302 continue to cool. The PCM 302 eventually cools to below its freezing point, returns to a solid state, and discharges heat energy while maintaining a constant temperature.

Following time T₄, the PCM has completely re-solidified and continued dissipation of heat reduces the temperature of both of the cells 118 and of the PCM 302.

The PCM 302 accordingly acts as a thermal buffer, inhibiting the spread of heat energy through the stack assembly 300 for a long enough period of time that the thermal runaway cell 118 exhausts itself before enough heat energy is absorbed by adjacent cells 118 to cause a catastrophic chain reaction. Heat that the thermal runaway cell 118 expels is dissipated in any one or more of several ways, such as via hot gases that the thermal runaway cell 118 expels, which are channeled out of the module 308, and by the other cell carrier assemblies 150 in the module 308, which heat is eventually radiated away or conducted to the heat sink 304. Heat is transferred to the other cell carrier assemblies 150 primarily via conduction along the stack assembly 300 or indirectly via the heat sink 304. The PCM 302 in the other cell carriers 100 in the stack assembly 300 accordingly also operate to help regulate the temperature of the assembly 300.

Thickness of the PCM 302 varies, for example, with the dimensions of the battery cell 118 and the characteristics of the PCM 302 used. For example, in embodiments in which the cell 118 is a 64 Ah lithium ion NMC cell the PCM 302 is typically between 1 mm and 3 mm in thickness. Equations (1) to (14), below, show an example of how to determine thickness of the PCM 302 when the cell 118 has dimensions of 255 mm wide×255 mm tall×8 mm thick, and the PCM 302 is the savE® HS 89 material from Pluss® Polymers Pvt. Ltd.

An experiment is conducted wherein a module is constructed without the PCM 302, and the thermal runaway cell 118 is forced into thermal runaway by overheating or overcharging. The volume and heat capacity of the neighboring cell 118 is first determined. The neighboring cell 118 is modeled as a rectangular aluminum block. Accordingly, its volume is determined by Equation (1):

V≡255 mm·255 mm·8mm (1)

The specific heat capacity of the neighboring cell 118 is given by Equation (2):

S_{Al}≡900 J kg⁻¹ K⁻¹ (2)

The density of the neighboring cell 118 is given by Equation (3):

ρ_{Al}≡2.7×10³ kg m⁻³ (3)

And the heat capacity of the neighboring cell is given by Equation (4):

C_{proxy}=ρ_{Al}·V·S_{Al}=1,264.086 J K⁻¹ (4)

The neighboring cell 118 is measured to reach a temperature of 120° C.; the excess heat energy absorbed by the neighboring cell 118 as a result of the thermal runaway cell 118 experiencing thermal runaway is determined using Equations (5) to (8). The peak temperature of the neighboring cell 118 in Kelvin is given by Equation (5):

Tₚₑₐₖ≡(273+120) K (5)

Assuming a melting point of 88° C., the melting point of the PCM 302 in Kelvin is given by Equation (6):

T_{pc}(273+88) K (6)

The difference between the peak and PCM melting temperatures in Kelvin is given by Equation (7):

ΔT≡(Tₚₑₐₖ−T_{pc}) (7)

And the heat energy required to elevate the temperature of the neighboring cell by this temperature difference is given by Equation (8):

Q≡C_{proxy}·ΔT=40.450752 kJ (8)

Assuming the PCM 302 has a latent heat of melting as given by Equation (9):

$${S}_{pcm} ≡ 180 \frac{kg}{kJ} \qquad ( 9 )$$

The mass of the PCM 302 required to absorb this energy in lieu of the neighboring cell 118 absorbing it is given by Equation (10):

$${m}_{pcm} ≡ \frac{Q}{{S}_{pcm}} = 0.2247264 kg \qquad ( 10 )$$

Equations (11) and (12) give the density of the PCM 302 and the required volume of the PCM 302:

$$\begin{matrix}{ρ}_{pcm} ≡ 1630 \frac{kg}{{m}^{3}} & ( 11 ) \\ {V}_{pcm} ≡ \frac{{m}_{pcm}}{{ρ}_{pcm}} & ( 12 )\end{matrix}$$

Equation (13) accordingly gives the thickness of the PCM 302 for each of the cell carriers 100:

$${t}_{pcm} ≡ \frac{{V}_{pcm}}{255 mm \cdot 255 mm} = 2.1202454 mm \qquad ( 13 )$$

And Equation (14) is the total mass of the PCM 302 used for a stack assembly 300 that comprises 24 of the cell carrier assemblies 150:

M_{pcm}=M_{pcm}·24=5.3934336 kg (14)

While in the depicted embodiments the PCM 302 is solid at normal operating temperatures of the battery cell 118 and melts when the cell 118 enters thermal runaway, in different embodiments (not depicted) the PCM 302 is liquid at normal operating temperatures of the battery cell 118 and evaporates when the cell 118 enters thermal runaway. For example, the PCM 302 may be water. In embodiments in which the PCM 302 is liquid, the evaporation temperature of the PCM 302 is selected to be between a normal operating temperature of the battery cell 118 and the self-heating temperature of the cell 118. As in the depicted embodiments, when the cell 118 operates within a range of normal operating temperatures, the evaporation temperature of the PCM 302 is, in certain embodiments, between an upper bound of the range and the self-heating point. Generally, each of the melting and evaporation temperatures of the PCM 302 represents a phase transition temperature of the PCM 302 at which the phase transition material transitions from a solid state to a liquid state or from a liquid state to a gaseous state, depending on whether the PCM 302 is solid or liquid during normal operation of the cell 118.

In embodiments in which the PCM 302 is liquid during the cell's 118 normal operation, the PCM compartment further comprises a gas vent (not depicted) that permits the PCM 302 to escape the compartment once vaporized if the cell 118 enters thermal runaway. In certain embodiments, the gas vent is permeable to liquid and gas; in certain other embodiments, the gas vent is gas permeable but not liquid permeable.

Directional terms such as “top”, “bottom”, “upwards”, “downwards”, “vertically”, and “laterally” are used in this disclosure for the purpose of providing relative reference only, and are not intended to suggest any limitations on how any article is to be positioned during use, or to be mounted in an assembly or relative to an environment.

Additionally, the term “couple” and variants of it such as “coupled”, “couples”, and “coupling” as used in this disclosure are intended to include indirect and direct connections unless otherwise indicated. For example, if a first article is coupled to a second article, that coupling may be through a direct connection or through an indirect connection via another article.

Furthermore, the singular forms “a”, “an”, and “the” as used in this disclosure are intended to include the plural forms as well, unless the context clearly indicates otherwise.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A cell carrier, comprising:
(a) a cell compartment for receiving a battery cell;
(b) a phase change material compartment thermally coupled to the cell compartment; and
(c) a phase change material located in the phase change material compartment, wherein the phase change material has a phase transition temperature between a normal operating temperature of the battery cell and a self-heating point of the battery cell, and wherein the phase change material transitions from a solid state to a liquid state or from a liquid state to a gaseous state when heated to the phase transition temperature.

2. The cell carrier of claim 1 wherein the battery cell is operable within a range of normal operating temperatures, and wherein the phase transition temperature is between an upper bound of the range of normal operating temperatures and the self-heating point of the battery cell.

3. The cell carrier of claim 1 wherein the phase transition temperature is a melting temperature of the phase change material.

4. The cell carrier of claim 3 wherein the cell compartment comprises a backing against which the battery cell is placed when the battery cell is in the cell compartment, and wherein the backing comprises a wall of the phase change material compartment.

5. The cell carrier of claim 4 wherein the phase change material directly contacts the backing.

6. The cell carrier of claim 4 wherein the carrier comprises a raised edge extending from the backing, wherein the raised edge comprises at least part of a periphery of the cell compartment on one side of the backing and of the phase change material compartment on an opposite side of the backing.

7. The cell carrier of claim 6 further comprising a phase change material compartment cap opposite the backing and coupled to the raised edge.

8. The cell carrier of claim 3 wherein the phase change material compartment is fluidly sealed.

9.-10. (canceled)

11. A battery module comprising a stack of cell carrier assemblies, wherein each of the cell carrier assemblies comprises:
(a) a cell carrier, comprising:
(i) a cell compartment for receiving a battery cell;
(ii) a phase change material compartment thermally coupled to the cell compartment; and
(iii) a phase change material located in the phase change material compartment, wherein the phase change material has a phase transition temperature between a normal operating temperature of the battery cell and a self-heating point of the battery cell, and wherein the phase change material transitions from a solid state to a liquid state or from a liquid state to a gaseous state when heated to the phase transition temperature; and
(b) a battery cell located within the cell compartment,
wherein for any two neighboring cell carrier assemblies that directly contact each other, the phase change material of one of the neighboring cell carrier assemblies is located between the battery cells of the neighboring cell carrier assemblies.

12. The battery module of claim 11 wherein the phase change material compartment of one of the neighboring cell carrier assemblies directly contacts the other of the neighboring cell carrier assemblies.

13. The battery module of claim 11 further comprising a heat sink thermally coupled to the stack and wherein each of the cell carrier assemblies further comprises a heat conductive sheet positioned to conduct heat from the battery cell to the heat sink.

14. The battery module of claim 13 wherein the heat conductive sheet is layered on the battery cell and extends out of the cell compartment to an edge of the cell carrier that contacts the heat sink.

15. The battery module of claim 13 wherein the phase change material compartment of one of the neighboring cell carrier assemblies directly contacts the heat conductive sheet of the other of the neighboring cell carrier assemblies.

16. The battery module of claim 11 wherein the battery cell is operable within a range of normal operating temperatures, and wherein the phase transition temperature is between an upper bound of the range of normal operating temperatures and the self-heating point of the battery cell.

17. The battery module of claim 11 wherein the phase transition temperature is a melting temperature of the phase change material.

18. The battery module of claim 17 wherein the cell compartment of each of the cell carrier assemblies comprises a backing against which the battery cell is placed when the battery cell is in the cell compartment, and wherein the backing comprises a wall of the phase change material compartment.

19. The battery module of claim 18 wherein the phase change material directly contacts the backing.

20. The battery module of claim 18 wherein the cell carrier of each of the cell carrier assemblies comprises a raised edge extending from the backing, wherein the raised edge comprises at least part of a periphery of the cell compartment on one side of the backing and of the phase change material compartment on an opposite side of the backing.

21. The battery module of claim 20 wherein the cell carrier of each of the cell carrier assemblies further comprises a phase change material compartment cap opposite the backing and coupled to the raised edge.

22. The battery module of claim 17 wherein the phase change material compartment is fluidly sealed.

23.-24. (canceled)
